(19) United States
(12) Patent Application Publication
(10) Pub. No.: US 2026/0200760 A1
(43) Pub. Date: Jul. 16, 2026

(54) Advanced Hybrid Eutecto Gels for Water Purification

(71) Applicant: Board of Trustees of Western Michigan University, Kalamazoo, MI (US)

(72) Inventors: Mert Atilhan, Portage, MI (US); Ahmad Al-Bodour, Kalamazoo, MI (US); Neha Sawant, Kalamazoo, MI (US)

(21) Appl. No.: 19/301,182

(22) Filed: Aug. 15, 2025

Related U.S. Application Data
(60) Provisional application No. 63/683,405, filed on Aug. 15, 2024.

(51) Int. Cl. C02F 1/00; C02F 101/30; C08J 3/075; C08K 5/06; C08K 5/09; C08K 5/19; C08L 33/08

(52) U.S. Cl. CPC C02F 1/001; C08J 3/075; C08K 5/06; C08K 5/09; C08K 5/19; C08L 33/08; C02F 2101/30; C02F 2209/03; C02F 2209/40; C02F 2209/445; C08J 2333/08

(57) ABSTRACT

Some embodiments of the present disclosure may include a eutectic gel for filtration of organic contaminants from water, including: a eutectic solvent, wherein the eutectic solvent comprises a terpenoid or quaternary ammonium salt HBA, and an organic HBD; and a gel matrix comprising a polymer capable of forming a gel. Some aspects of the present disclosure may include a method of making a eutectic gels. Other aspects of the present disclosure may include a method of filtering organics contaminants from water, including placing at least one eutectic gel, comprising a collection surface and filtration surface in contact with water to be filtered on the filtration surface; and collecting filtered water that has passed through the eutectic gel.

### CROSS REFERENCE TO RELATED APPLICATIONS

The present disclosure claims priority to U.S. Provisional Application No. 63/683,405, filed Aug. 15, 2024, the contents of which are claimed by reference in their entirety.

### TECHNICAL FIELD

The present disclosure relates to eutectic gels for the filtration of organic contaminants, such as phenolics and PFAS, from water, for use in water purification (such as, e.g., purification of drinking water or effluent), methods of manufacture thereof and methods of water purification using the gels described herein.

### BACKGROUND OF THE INVENTION

Deep eutectic solvents (DESs) have been increasingly used as environmentally friendly replacements for traditional extraction solvents, which may be costly and damaging to the environment. DESs are usually mixtures of separate components that alone may have high melting points, and thus be impractical as solvents, but show lowered melting points when mixed. The lowered melting points are thought to be due to hydrogen bonding among the different components. DESs are most usually formed from a mixture of a hydrogen bond acceptor (HBA) and hydrogen bond donor (HBD). These solvents may also have novel and improved extraction properties.

DESs have been used as solvents in gel systems (known in these contexts as eutectogels) as well for improved chemical and mechanical properties. Potential uses may range from energy storage, wearable sensors, electrochromic displays and others; properties may be adjusted by adjusting the identity and composition of individual components. Gel scaffoldings can made out of diverse materials and utilize various types of chemical bonds between gel agent components, such as covalent linkages and non-covalent linkages (such as hydrogen bonding and the like). The latter, in general, tend to be less brittle and offer greater energy dissipation properties. (Panzer, Material. Adv. (2022)).

Using eutectogels over DESs alone offer several advantages, including but not limited to: (1) Enhanced Stability: Gels provide a more stable matrix for the DES, reducing the likelihood of solvent loss and degradation over time; (2) Improved Mechanical Properties: Eutectogels exhibit better mechanical properties, such as flexibility and strength, which make them easier to handle and integrate into industrial applications; (3) Controlled Release and Regeneration: Gels can facilitate controlled release and easier regeneration of the captured filtrates. The porous structure of gels can enhance the adsorption capacity and selectivity for specific filtrates; (4) Scalable Processes: The production and application of eutectogels can be scaled up efficiently for industrial use. The gelation process, involving UV or thermal curing, can be applied to large batches, and the gels can be formed into various shapes and sizes to fit different filtration systems. This scalability makes eutectogels a practical solution for large-scale gas capture operations in various industrial settings. (5) Minimized Leaching: The gel matrix can reduce the leaching of DES components into the surrounding environment, which is particularly important for maintaining the integrity and performance of the separation system. (6) Tunability: The properties of eutectogels can be easily tuned by modifying the gel composition, crosslinking density, and the type of DES used, allowing for customized solutions for specific applications.

Further, gels can incorporate physical structural elements like fabric backers etc. that can further increase the flexibility, strength, porosity and other properties of the gels.

The main objective of this disclosure is the development of eutectic gels for the filtration of organic contaminants, such as phenolics and PFAS, from water, for use in water purification (such as, e.g., purification of drinking water or effluent), methods of manufacture thereof and methods of water purification using the gels described herein.

### SUMMARY OF THE INVENTION

Some embodiments of the present disclosure may include a eutectic gel for filtration of organic contaminants from water, including: a eutectic solvent, wherein the eutectic solvent comprises a terpenoid or quaternary ammonium salt HBA, and an organic HBD; and a gel matrix comprising a polymer capable of forming a gel.

Further embodiments may include a backer incorporated into or attached to the gel matrix. In some embodiments, the backer may be paper, nylon, or felt.

In still other embodiments, the HBA may include a terpenoid selected from one or more of thymol, menthol, piperitone, linalyl acetate, eugenol, citronellol, linalool, geraniol, and 1,8-cineole. In others, the HBA may include a quaternary ammonium salt selected from one or more of choline chloride; tetraethylammonium bromide; tetramethylammonium chloride; tetrabutylammonium bromide; benzyltrimethylammonium chloride; cetyltrimethylammonium bromide; methyltrioctylammonium chloride; tetrabutylammonium hydrogen sulfate; hexadecyltrimethylammonium bromide; tetrakis(hydroxymethyl)phosphonium chloride; tetraoctylammonium bromide; tri-n-octylmethylammonium chloride; tetrabutylammonium bromide.

In other embodiments, the organic HBD comprises a glycol, terpene, sugar, fatty acid, polyol, amino acid, organic acid, glycerol or urea. In others, the HBD is a medium-chain fatty acid, selected from lauric acid, linoleic acid, decanoic acid, caproic acid, caprylic acid.

In yet other embodiments, the gel matrix comprises a cross-linked polymer. In others, the cross-linked polymer is derived from ethyl acetate and PEDGA subunits. In some embodiments, the gel has an average porosity of 50-75 ml/min at 1000 KPa Clamping pressure.

Some aspects of the present disclosure may include a method of making a eutectic gel, including: combining a terpenoid or quaternary ammonium salt HBA and an organic HBD to form a eutectic solvent; combining the eutectic solvent with a gel precursor solution and a porogenic solvent in a gelation chamber; and gelling the combined eutectic solvent and gel precursor solution. Other aspects may further include adding a backer to the gelation chamber prior to gelling the combined eutectic solvent and gel precursor solution.

In still other aspects, the HBA may include a terpenoid selected from one or more of thymol, menthol, piperitone, linalyl acetate, eugenol, citronellol, linalool, geraniol, and 1,8-cineole. In others, the HBA may include a quaternary ammonium salt selected from one or more of choline chloride; tetraethylammonium bromide; tetramethylammonium chloride; tetrabutylammonium bromide; benzyltrimethylammonium chloride; cetyltrimethylammonium bromide; methyltrioctylammonium chloride; tetrabutylammonium hydrogen sulfate; hexadecyltrimethylammonium bromide; tetrakis(hydroxymethyl)phosphonium chloride; tetraoctylammonium bromide; tri-n-octylmethylammonium chloride; tetrabutylammonium bromide.

In other aspects, the organic HBD comprises a glycol, terpene, sugar, fatty acid, polyol, amino acid, organic acid, glycerol or urea. In others, the HBD is a medium-chain fatty acid, selected from lauric acid, linoleic acid, decanoic acid, caproic acid, caprylic acid.

In yet other aspects, the gel matrix comprises a cross-linked polymer. In others, the cross-linked polymer is derived from ethyl acetate and PEDGA subunits. In some embodiments, the gel has an average porosity of 50-75 ml/min at 1000 KPa Clamping pressure.

Other aspects of the present disclosure may include a method of filtering organics contaminants from water, including placing at least one eutectic gel, comprising a collection surface and filtration surface in contact with water to be filtered on the filtration surface; and collecting filtered water that has passed through the eutectic gel. Other aspects may include increasing flow of water through the eutectic gel via vacuum pressure on the collection surface.

In other aspects, the eutectic gel includes a eutectic solvent, wherein the eutectic solvent includes a terpenoid or quaternary ammonium salt HBA, and an organic HBD; and a gel matrix comprising a polymer capable of forming a gel. In others, the gel further includes a backer incorporated into or attached to the gel matrix, where the backer may be made of nylon, paper or felt.

In still other aspects, the HBA may include a terpenoid selected from one or more of thymol, menthol, piperitone, linalyl acetate, eugenol, citronellol, linalool, geraniol, and 1,8-cineole. In others, the HBA may include a quaternary ammonium salt selected from one or more of choline chloride; tetraethylammonium bromide; tetramethylammonium chloride; tetrabutylammonium bromide; benzyltrimethylammonium chloride; cetyltrimethylammonium bromide; methyltrioctylammonium chloride; tetrabutylammonium hydrogen sulfate; hexadecyltrimethylammonium bromide; tetrakis(hydroxymethyl)phosphonium chloride; tetraoctylammonium bromide; tri-n-octylmethylammonium chloride; tetrabutylammonium bromide.

In other aspects, the organic HBD comprises a glycol, terpene, sugar, fatty acid, polyol, amino acid, organic acid, glycerol or urea. In others, the HBD is a medium-chain fatty acid, selected from lauric acid, linoleic acid, decanoic acid, caproic acid, caprylic acid.

In yet other aspects, the gel matrix comprises a cross-linked polymer. In others, the cross-linked polymer is derived from ethyl acetate and PEDGA subunits. In some embodiments, the gel has an average porosity of 50-75 ml/min at 1000 KPa clamping pressure.

In other aspects, the organic contaminants to be filtered comprise one or more of phenolics, methylparabens, PFAS, pesticides, pharmaceuticals, endocrine disruptors, industrial chemicals, personal care products. In others, the eutectic gel may be washed and reused after reaching capacity. In others, two or more eutectic gels may be stacked while in use for filtration.

Other features and advantages of the present invention will become apparent from the following detailed description, including the drawing. It should be understood, however, that the detailed description and the specific examples, while indicating preferred embodiments, are provided for illustration only, because various changes and modifications within the spirit and scope of the invention will become apparent to those skilled in the art from the detailed description.

### DESCRIPTION OF THE DRAWINGS

FIG. 1 is a schematic diagram of an example aspect of the present disclosure in fabricating and using an example embodiment eutectic gel;

FIG. 2A shows an SEM image of an example embodiment gel made with CIN-DeA (1:1); DES-EA-DMSO 1:2:2 vol:vol; 20% PEGDA; 5% PI poured over felt backing at a 500 μm magnification;

FIG. 2B shows an SEM image of the example embodiment gel of FIG. 2A at a 100 μm magnification;

FIG. 2C shows an SEM image of the example embodiment gel of FIG. 2A at a 50 μm magnification, the width of the measured pore channel is 203.1 μm;

FIG. 2D shows the SEM image of another region of the example embodiment gel of FIG. 2A at a 50 μm magnification;

FIG. 3A shows an SEM image of an example embodiment gel made with: CIN-DeA (1:1); DES-EA-DMSO 1:2:4 vol:vol; 20% PEGDA; and 5% PI poured over felt backing (curved fibers) at a 500 μm magnification;

FIG. 3B shows an SEM image of the example embodiment gel of FIG. 3A at a 100 μm magnification;

FIG. 3C shows the SEM image of another region of the example embodiment gel of FIG. 3A at a 100 μm magnification;

FIG. 3D shows the SEM image of an example embodiment gel of FIG. 3A at a 50 μm magnification;

FIG. 4A shows an SEM image of an example gel backed with felt (curved fibers) made with: CIN-DeA (1:1), DES-EA-DMSO 1:2:2 Vol:vol; 20% PEGDA; 5% PI at 50 μm magnification;

FIG. 4B shows an SEM image of an example gel backed with felt (curved fibers) made with: CIN-DeA (1:1), DES-EA-DMSO 1:2:4 Vol:vol, 20% PEGDA, 5% PI, at 100 μm magnification;

FIG. 5 shows the repeated extraction efficiency of 250 mg/L 2-nitrophenol with an example embodiment gel formulation of CIN-DeA (1:1), DES:EA (1:2), PEGDA 20 wt. % EA, PI-5 wt % EA, 2 ml DMSO;

FIG. 6 shows the extraction efficiency to various concentrations of 2-nitrophenol (50 mg/L to 500 mg/L) using an example embodiment gel of CIN-DeA (1:1), DES:EA (1:2), PEGDA 20 wt. % EA, PI-5 wt % EA, 2 ml DMSO;

FIG. 7 shows the marked change in color between the control solutions (containing 2-nitrophenol at the indicated concentrations) and the filtrate after passing through the gel described in FIG. 6.

### DESCRIPTION OF THE INVENTION

### Definitions

The terms used in this specification generally have their ordinary meanings in the art, within the context of this subject matter and in the specific context where each term is used. Certain terms are defined below to provide additional guidance in describing the compositions and methods of the disclosed subject matter and how to make and use them.

As used in the specification and the appended claims, the singular forms “a,” “an,” and “the” include plural referents unless the context clearly dictates otherwise. Thus, for example, reference to “a compound” includes mixtures of compounds.

The term “about” or “approximately” means within an acceptable error range for the particular value as determined by one of ordinary skill in the art, which will depend in part on how the value is measured or determined, i.e., the limitations of the measurement system. For example, “about” can mean within three or more than three standard deviations, per the practice in the art. Alternatively, “about” can mean a range of up to 20%, preferably up to 10%, more preferably up to 5%, and more preferably still up to 1% of a given value. Also, particularly with respect to systems or processes, the term can mean within an order of magnitude, preferably within five-fold, and more preferably within two-fold, of a value.

It should be appreciated by those skilled in the art that the conception and specific embodiment disclosed may be readily utilized as a basis for modifying or designing other structures for carrying out the same purposes of the present application. It should also be realized by those skilled in the art that such equivalent constructions do not depart from the spirit and scope of the application as set forth in the appended claims.

Eutectic solvents. In aspects and embodiments of the present disclosure, various eutectic solvent components may be used, not limited to the two (or more) solvents used in the example solvents discussed herein.

In some embodiments, one or more HBAs are combined with one or more HBDs to form the eutectic solvent.

In general, the combination of the HBD and HBA should be relatively immiscible in water and other polar solvents in order to resist leaching of the eutectic solvent from the gel during use.

In some embodiments, terpenoids may be used as the HBA. In some embodiments, thymol, menthol, piperitone, linalyl acetate, eugenol, citronellol, linalool, geraniol, and/or 1,8-cineole (eucalyptol) and the like may be used. In some embodiments, 1,8-cineole may be used.

In some embodiments, quaternary ammonium salts may be used as the HBA, for example but not limited to, choline chloride; tetraethylammonium bromide; tetramethylammonium chloride; tetrabutylammonium bromide; benzyltrimethylammonium chloride; cetyltrimethylammonium bromide; methyltrioctylammonium chloride; tetrabutylammonium hydrogen sulfate; hexadecyltrimethylammonium bromide; tetrakis(hydroxymethyl)phosphonium chloride; tetraoctylammonium bromide; tri-n-octylmethylammonium chloride; tetrabutylammonium bromide. Various anions, usually with a single negative charge, may be used to form quaternary ammonium salts, such as chloride, bromide, fluoride, iodide, sulfate, nitrate, nitrite and the like.

Several kinds of HBDs may be used in the present disclosure. For example, in some embodiments and aspects, one or more organic compounds may be used as HBDs, such as glycols (such as ethylene glycol, propylene glycol, etc.); terpenes (such as menthol, thymol, geraniol, etc.); sugars (glucose, fructose, etc.); fatty acids (lauric acid, linoleic acid, decanoic acid, caproic acid, caprylic acid, etc.); polyols (xylitol, sorbitol, etc.); amino acids (glycine, proline, etc.); organic acids (acetic acid, citric acid, oxalic acid, etc.); glycerol; and urea. In some embodiments, a non-toxic, naturally occurring organic compound HBD is used

In some embodiments, a medium-chain fatty acid is used as the HBD. In some embodiments, decanoic acid is used as the HBD. An advantage of medium chain fatty acid and some of the other organics listed above is that they are in general non-toxic and/or biodegrade easily. Another advantage in certain organic compounds is their relative hydrophobicity alone or in combination with an HBA.

Gel agents. Various gelling agents may be used in aspects and embodiments of the present disclosure. Ethyl acrylate-based gels have an advantage of ease of formation and use, durability and non-biodegradability. Cross-linking agents such as PEDGA, which cross-links in the presence of a photo initiator (e.g., 1-hydroxycyclohexyl phenyl ketone) and UV light, offer advantages of in-situ polymerization under mild conditions, to allow porous gel structures and a high level of surface area and/or pores to adjust filtration and absorption capacity, stability over time, and speed. However, as known to person of skill in the art, various gelation agents and gelation methods, including UV curing, thermal and/or chemical curing may be used in various embodiments and aspects of the present disclosure.

Various gelation containers may be used, such as watch glasses, plastic and soda glass, petri dishes, and the like. In some embodiments, the gel solutions should be covered during gelation to minimize evaporation of the gel components. Persons of skill in the art will realize any suitable container that does not block the requisite UV wavelengths (when UV curing is used) while minimizing evaporation during curing should suffice.

Gelation solvent. In some aspects and embodiments, DMSO is used as the solvent for the gel agents. DMSO has an advantage of low toxicity, ability to dissolve polar and apolar solutes, and good porosity formation in gelation reactions. Other gelation solvents known in the art may be used in some aspects and embodiments.

Backing. In some aspects and embodiments, the gel may be attached to or otherwise be placed in contact with a backing material to add strength and flexibility to the filtration media. Suitable attachment means, such as partially melting the gel into the backing material, may be used. In other embodiments, backing materials may be mechanically held to the gel, such as in a filtration device. In some aspects, the gel is poured over and solidifies around the backing material so it is directly incorporated into the gel. An advantage of the latter is that no attachment means are needed. A second advantage is that with some backing materials, i.e., such as fibrous backing materials, the fibers of the material can aid in creating porous channels in the gel material. Suitable backing materials include paper, nylon, felt and others known to persons of skill in the art; the above-listed materials may be chosen and/or manufactured with varying fiber sizes (if a fibrous material is chosen), porosities, thicknesses as needed. In particular, an advantage of felt is that it is flexible, strong, resistant to water degradation, and has a porous structure that allows for sufficient infusion into the support matrix, offering an improvement over previous materials like paper and nylon mesh.

Water-borne contaminants. In general, eutectic gels of the present disclosure may be used to filter or capture dissolved chemicals in water from various sources such as industrial effluent, wastewater, drinking water and the like. In some embodiments, other filters may be used upstream to capture suspended biotic and abiotic solids prior to filtering with the presently disclosed gels. Eutectic solvents may be chosen and gel composition and porosities adjusted to potentially filter out several kinds of organic contaminants. Such contaminants range from phenolics (e.g., 2-nitrophenol) and methylparabens, to PFAS (per- and polyfluoroalkyl substances); pesticides (e.g., atrazine, glyphosate); pharmaceuticals (e.g., antibiotics, painkillers); endocrine disruptors (e.g., bisphenol A, etc. . . . ); industrial chemicals (e.g., benzene, toluene, etc. . . . ); personal care products (e.g., triclosan, phthalates, etc. . . . )

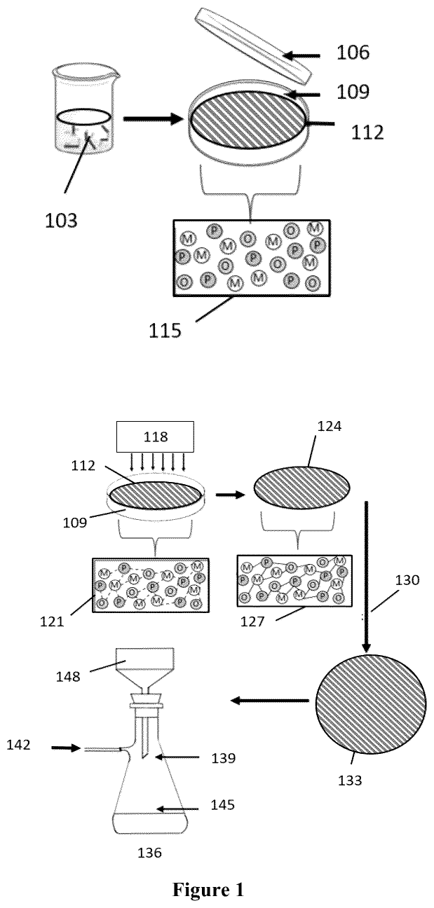

Methods of Manufacture. An example illustrative aspect of manufacture of the described eutectic gels is shown in FIG. 1. A desired eutectic solvent (e.g. CIN-DeA) is combined with a gel precursor solution (e.g., EA+PEGDA crosslinker) along with a porogenic solvent (e.g. DMSO). The mixture is poured into a gelation chamber, here a glass petri dish with a lid (e.g., a glass lid) to avoid evaporation of solvents during curing. In some embodiments, the container and/or lid are transparent to UV light to allow the gel to be formed via UV curing. In some aspects, the mixture is poured over a suitable backer media placed in the gelation chamber (e.g., felt).

Still referring to FIG. 1, in some aspects the gel mixture is exposed to UV light in order to initiate the cross-linking reaction to form a cured gel. The porogenic solvent is then washed from the gel with deionized and/or distilled water and methanol and hot air dried. The resultant gel, in certain embodiments, has sufficient pores and/or channels to provide sufficient volume/surface area within the gel for efficient filtration.

Methods of use. Still referring to FIG. 1, gels can be used in a standard Buchner funnel setup connected to a vacuum pump. In general, passage of the liquid to be filtered should be aided via a force provided by a vacuum and/or gravity, pressure on the front surface of the gel (such as generated by the liquid to be filtered, e.g., water flow rate). Gels of the present disclosure may be used in flow-through systems where water passes continuously through the gel. For instance, gels can be used as rolled sheets of membranes in a container, such as a cylindrical container that allows water to push through the membrane from inside to outside.

Operational conditions may be varied in terms of temperature, including for instance room temperature, and pH, including for instance mildly acidic to basic conditions, to optimize filtration for a particular use/contaminant. Gels of the present disclosure may be operational at various flow rates and/or pressures.

While gels that have reached capacity may be disposed of, in some embodiments and aspects, the gels are reusable. In some aspects, used gels may be thoroughly rinsed using deionized (DI) water to remove loosely bound contaminants and particles from the gel surface. This step helps to clear the major debris before more intensive cleaning.

Next, the gels may be backwashed with dilute alcoholic solutions, such as with 10% ethanol solution without disrupting the gel's integrity (i.e., up to 10% or less). The alcoholic solution helps to dissolve organic contaminants and disrupts weak hydrogen bonds that may have formed between the contaminants and the gel. Further, a dilute acidic solution may be used to remove any metal ions or other contaminants that are more soluble in acidic conditions. Further, the gel may be rinsed with a dilute alkaline solution to neutralize the gel and dissolve organic acids and other acid-soluble contaminants. In some aspects, the acidic/basic steps may be reversed as needed. After each pH adjustment step, the gel may be needed to be thoroughly rinsed with DI to remove any residual acid or alkali.

Another, or additional method for reuse may be ultrasonic cleaning. Gels may be placed in an ultrasonic cleaning bath filled with DI water. Ultrasonic waves help to dislodge contaminants from the gel matrix by creating microscopic cavitation bubbles that implode and generate localized high-pressure zones. Typically, a 10-20 minute cycle should be sufficient, but this can be adjusted based on the extent of contamination and gel properties.

A further method may be heat treatment. For gels that can withstand heat, a controlled heating process can be employed. The gel is heated to a temperature that is sufficient to denature and remove bound contaminants without damaging the gel structure. Typically, this could be in the range of 50-70° C. In an example aspect, the used gel is heated in an oven or a water bath for 30-60 minutes, then allowed to cool naturally. After heating, rinse with DI water to remove any loosened contaminants.
Example 1. Eutectic gels were developed to filter 2-nitrophenol, which can be soil contaminant, usually from munitions or fabric industry sources.

Materials. The test compound 2-Nitrophenol (98% purity, CAS-88-75-5, Lot-5002P16P) was purchased from Alfa Aesar. Dimethyl sulfoxide (DMSO) (99.9% purity, CAS-67-68-5, 472301-1L) was purchased from Sigma Aldrich. Polyethylene glycol diacrylate (PEGDA) (CAS-26570-48-9, Source-MKCS1268) was purchased from Sigma Aldrich. Felt material was purchased from Crafter's Square Felt Rolls (12.125×48 in). 1,8-Cineole (Cin) (CAS RN-470-82-6, Lot-V67AEFL) was purchased from TCI. Decanoic acid (DeA) (99% purity, CAS-334-48-5, Lot-A0428958) was purchased from Acros Organics. Photo initiator, 1-hydroxycyclohexyl phenyl ketone (99% purity, CAS-947-19-3, Source-MKCQ1615) was purchased from Sigma Aldrich. Ethyl Acrylate (99.5% purity, CAS-140-88-5, Source-SHBN7157) was purchased from Sigma Aldrich. HPLC grade DI water purchased from Sigma Aldrich (CAS-7732-18-5, Lot-SHBK2015) was used to prepare all stock contaminated water solutions.

Preparation Of Deep Eutectic Solvents (DES). A DES comprised of a hydrogen bond acceptor (HBA), and a hydrogen bond donor (HBD) was formulated. The terpenoid 1-8-Cineole was used as HBA and decanoic acid (DeA) was used as an HBD. The mixture was prepared at a temperature of 40° C. at a 1:1 molar mixing ratio. DeA is solid at room temperature; it was liquefied using a water bath pre-set to 45° C. and used for further mixture preparation.

### Fabrication of the Porous Membrane

Preparation of DES-Monomer-Porogenic Solvent Mixture. A total of 5% of the photo initiator, 1-hydroxycyclohexyl phenyl ketone, was dissolved in the desired amount of porogenic solvent (DMSO). The weight of the photo-initiator was based on the weight of the monomer. Here, ethyl acrylate was used as the monomer. A total of e.g., 2 ml ethyl acrylate, based on the ratios in the following paragraph, was added to the mixture. The solution was prepared on a hot plate (at room temperature, no heat) with a magnetic stirrer, and the reaction was carried out in a closed 20 ml glass vial. The reaction was continued until a clear solution was formed before proceeding to the next step. The desired volume of prepared DES (CIN-DeA 1-1) was added. A total of 20% PEGDA, based on the weight of ethyl acrylate, was added to the mixture.

To assess porogenic solvent volume optimization, gel solvent mixtures were prepped as below: (1) DES-ethyl acrylate-DMSO 1:2:1; (2) DES-ethyl acrylate-DMSO 1:2:2; (3) DES-ethyl acrylate-DMSO 1:2:3; (4) DES-ethyl acrylate DMSO 1:2:4.

Petri Dish and Felt Size. A 9 cm glass petri dish was used and felt was cut appropriately (around 8.8 cm diameter) to fit the bottom of the petri dish. A glass lid was used to cover the petri dish.

UV Curing. The prepared DES-Monomer-Porogenic Solvent Mixture was poured on the circular cut felt and UV-cured at 280 nm and 100 watts for 30 mins.

Washing. After UV curing, the gel was thoroughly rinsed with DI water, followed with 100% methanol. To ensure all the excess DMSO was washed out, an additional rinse was given with DI water. The gel was then heat dried using a hair dryer. A schematic diagram of the procedure can be seen in FIG. 1.

### Testing

Porosity. The air porosity of the prepared gels were tested with PPS Parker Print Surf porosity measurement device, at 1000 Kpa clamping pressure. A total of 10 measurements were recorded for each gel to determine the average porosity for each gel.

SEM. A scanning electronic microscopy (SEM) was used to examine the surface topography and the cross-section image of the gel. The samples were sputter coated with gold for 0.5 min before analysis. Surface topography and cross-sectional morphology were assessed.

### Extraction Efficiency for 2-Nitrophenol

Calibration Curve. To assess 2-nitrophenol extraction efficiency from water, via spectroscopy, aqueous stock solutions of 2-nitrophenol were prepared for 0 to 60 mg/L concentrations. For a blank, HPLC DI water was used. An A-Max absorbance of 278 nm was used. Triplicates of each concentration were taken.

Vacuum Filtration. Several Concentrations of 2-nitrophenol were prepared. A total of 10 ml of each solution was filtered through the gel, via a Buchner funnel and vacuum flask were used along with a vacuum pump connected to it. The filtrate was analyzed by UV-Vis, to measure the absorbance of 2-nitrophenol; the final concentration was calculated using the calibration curve of 2-nitrophenol.

### Results

Porogenic solvent optimization. For porogenic solvent optimization, DES-Ethyl Acrylate-DMSO ratios of 1:2:1, 1:2:2, 1:2:3, 1:2:4 were used, i.e., varying the DMSO/Porogenic solvent volumes of 1 ml, 2 ml, 3 ml and 4 ml for the gel volumes used here. The 1 ml DMSO formulation did not cover the 8.8 cm felt adequately. The 2 ml, 3 ml, and 4 ml volume DMSO gels were analyzed further.

A concentration of 250 mg/L 2-nitrophenol was selected for further tests; as discussed more fully below, the 2 ml DMSO gel showed the highest extraction efficiency among all the other gels.

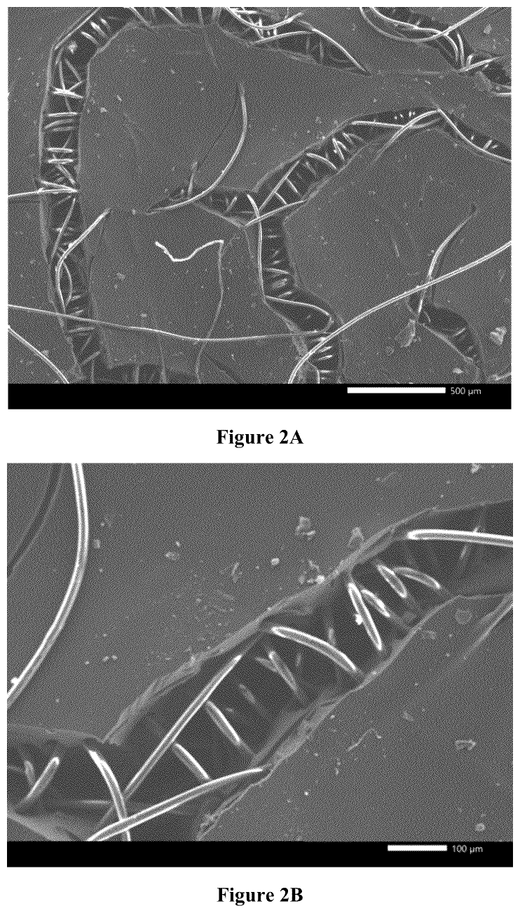

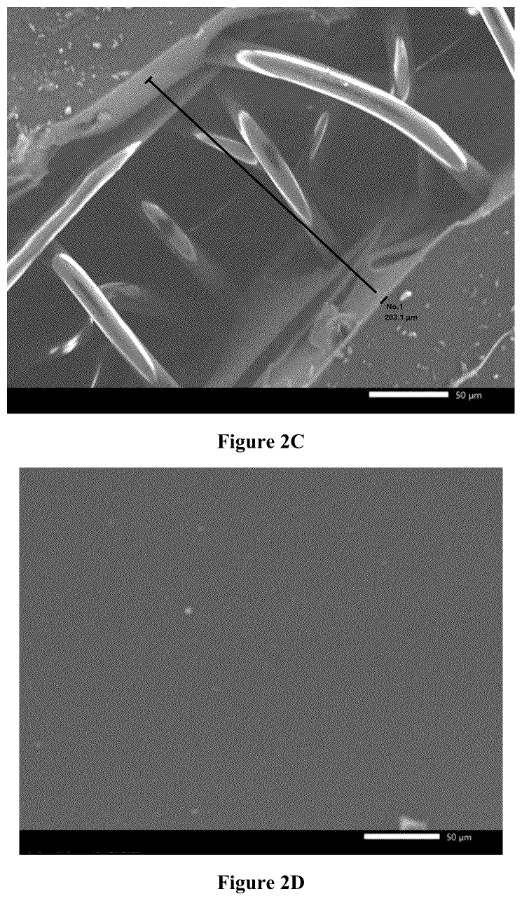

SEM. FIGS. 2a-d show SEM images of an example embodiment gel poured over felt (curved and straight fibers in images) containing: CIN-DeA (1:1); DES-EA-DMSO 1:2:2 vol:vol; 20% PEGDA; and 5% PI. The SEM images were recorded at (a) 500 μm, (b) 100 μm, (c) and 50 μm magnification. The first three images show the channel formation, while the last image (d) shows the neat gel portion of the gel at 50 μm magnification.

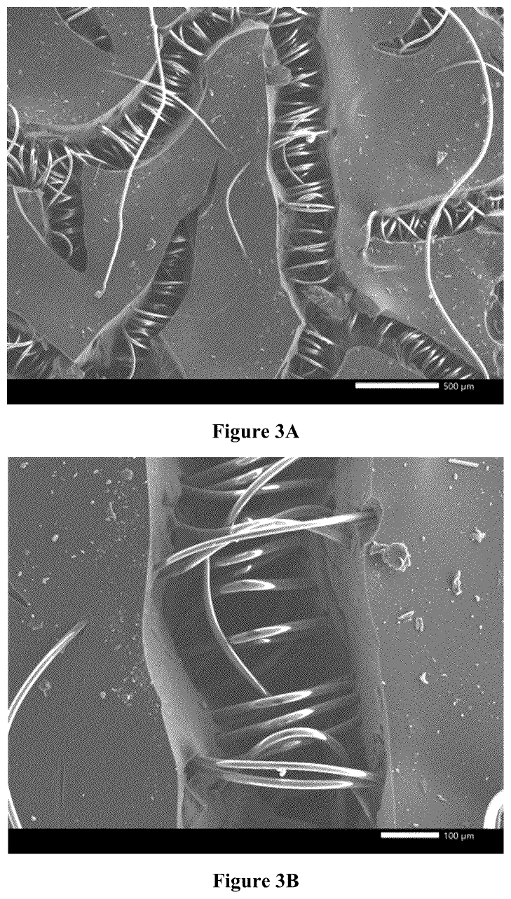

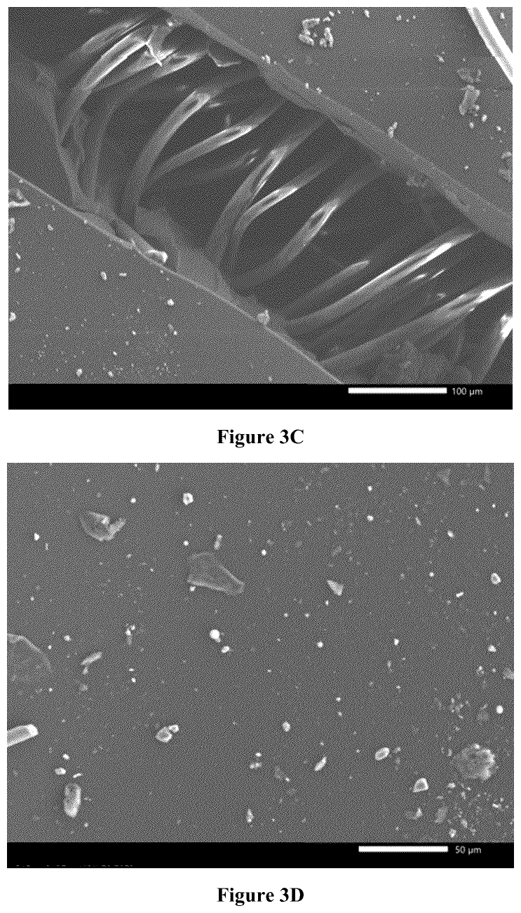

FIGS. 3a-d show SEM images of an example embodiment gel made with Felt (curved and straight fibers) with: CIN-DeA (1:1); DES-EA-DMSO 1:2:4 vol:vol; 20% PEGDA; and 5% PI. The SEM images were recorded at (a) 500 μm, (b) 100 μm, (c) and 50 μm magnification. The first three images show the channel formation, while the last image (d) shows the neat gel portion of the gel at 50 μm magnification.

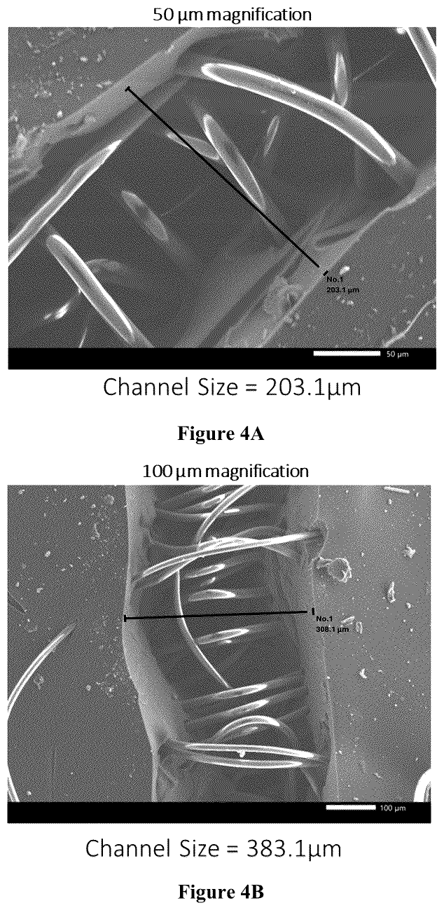

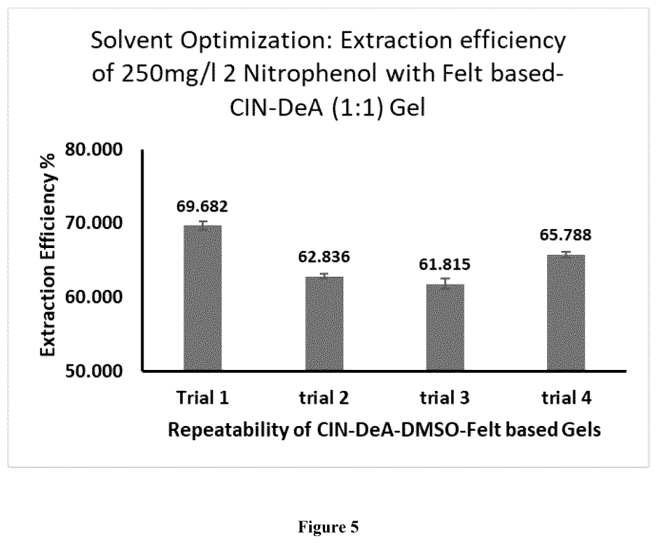

FIG. 4 shows that an increase in porogenic solvent volume in the gel increased the size of the microchannel. FIG. 4a shows an SEM image of an example gel backed with felt (curved fibers) with: CIN-DeA (1:1), DES-EA-DMSO 1:2:2 Vol:vol; 20% PEGDA; 5% PI at 50 μm magnification. FIG. 4b shows an SEM image of Felt of an example gel backed with felt (curved fibers) with: CIN-DeA (1:1), DES-EA-DMSO 1:2:4 Vol:vol, 20% PEGDA, 5% PI, at 100 μm magnification. The channel sizes shown were 203.1 μm, and 383.1 μm, respectively.
Example 2. Repeatability study. Extraction efficiency of CIN-DeA (1:1), DES:EA (1:2), PEGDA 20 wt. % EA, PI-5 wt % EA, 2 ml DMSO. Four gels of the formulation given above were tested individually with 250 mg/l of 2 Nitrophenol to assess the repeatability of the extraction efficiency of the same formulation. Triplicate samples of each filtrate were analyzed by UV-Vis. FIG. 5 shows the results.

The porosity of each of the four gels was measured with a porosimeter. The data are represented in the table below.

TABLE 1
Average porosity of example embodiment gel (CIN-DeA (1:1),
DES:EA 1:2, PEGDA 20 wt. % EA, PI 5 wt % EA, 2 ml DMSO.

| | Porosity (ml/min) at 1000 KPa | | | |
|---|---|---|---|---|
| 1 ml DES: 2 ml | Clamping pressure | | | |
| EA: DMSO* | Gel 1 | Gel 2 | Gel 3 | Gel 4 |
| 1 | 21.40 | 51.50 | 64.97 | 77.64 |
| 2 | 27.85 | 81.33 | 34.13 | 66.98 |
| 3 | 21.33 | 121.50 | 42.63 | 66.39 |
| 4 | 17.19 | 58.52 | 75.80 | 59.21 |
| 5 | 32.61 | 78.52 | 54.78 | 60.87 |
| 6 | 29.78 | 55.75 | 89.06 | 68.52 |
| 7 | 28.50 | 66.10 | 46.16 | 69.89 |
| 8 | 24.90 | 32.60 | 43.18 | 73.95 |
| 9 | 23.85 | 74.71 | 66.29 | 52.89 |
| 10 | 22.97 | 53.17 | 49.16 | 63.57 |
| Average | 25.04 | 67.37 | 56.62 | 65.99 |
| Porosity | | | | |
| (ml/min) | | | | |
| Standard | 4.405 | 22.761 | 16.230 | 6.866 |
| Deviation | | | | |

Example 3. Re-usability Study (4 ml DMSO gels). The extraction efficiency over multiple uses of an example embodiment of gel (CIN-DeA (1-1), DES:EA 1:2, PEGDA 20 wt. % EA, PI-5 wt % EA, 4 ml DMSO) was tested.

A total of 250 mg/L of 2 Nitrophenol was filtered through the same gel 3 times. After every filtration, the filtrate was analyzed by UV-Vis. No backwashing was performed between filtrations and absorbance was used to obtain the final concentration using the calibration curve developed above.

TABLE 2
Extraction Efficiency of example embodiment gel (CIN-DeA (1:1),
DES: EA 1:2, PEGDA 20 wt. % EA, PI 5 wt % EA, 4 ml DMSO).

| | | | | |
|---|---|---|---|---|
| Average | 0.065 | 0.062 | 0.069 | 0.065 |
| Blank | | | | |

CIN-DeA (1:1), DES: EA 1:2, PEGDA 20 wt.% EA, PI 5 wt % EA,
4 ml DMSO

| | | | Final | | Average |
|---|---|---|---|---|---|
| Initial | Absorbance | | Concen- | Extraction | Extraction |
| Concentra- | From | Corrected | tration | Efficiency | Efficiency |
| tion | Instrument | Absorbance | mg/L | % | % |
| 250 | 2.351 | 2.286 | 114.25 | 54.299 | 54.107 |
| 250 | 2.378 | 2.313 | 115.60 | 53.762 | |
| 250 | 2.353 | 2.288 | 114.35 | 54.259 | |
| 250 | 2.374 | 2.309 | 115.40 | 53.841 | 54.677 |
| 250 | 2.324 | 2.259 | 112.91 | 54.836 | |
| 250 | 2.298 | 2.233 | 111.62 | 55.354 | |
| 250 | 2.206 | 2.141 | 107.04 | 57.185 | 55.938 |
| 250 | 2.261 | 2.196 | 109.77 | 56.090 | |
| 250 | 2.339 | 2.274 | 113.66 | 54.538 | |

Example 4. Extraction Efficiency of 2 stacked gels DES-EA-DMSO 1:2:2. Individual Gels were made of the same formulation and same technique as in Examples 3 and 4. This time, the efficiency of two stacked gels were tested using 250 mg/l 2-nitrophenol.

TABLE 3
Extraction Efficiency of example embodiment (two stacked gels, CIN-DeA (1:1),
DES:EA 1:2, PEGDA 20 wt. % EA, PI 5 wt % EA, 2 ml DMSO)

| | | | | |
|---|---|---|---|---|
| Average | 0.046 | 0.047 | 0.047 | 0.047 |
| Blank | | | | |

Two stacked gels, CIN-DeA (1:1), DES:EA 1:2, PEGDA
20 wt. % EA, PI 5 wt % EA, 2 ml DMSO

| | Absorbance | | Final | Extraction | Average | |
|---|---|---|---|---|---|---|
| Initial | From | Corrected | Concentration | Efficiency | Extraction | Standard |
| Concentration | Instrument | Absorbance | mg/L | % | Efficiency % | Deviation |
| 250 | 1.133 | 1.086 | 54.58 | 78.167 | 77.855 | 0.252 |
| 250 | 1.149 | 1.102 | 55.38 | 77.848 | | |
| 250 | 1.164 | 1.117 | 56.13 | 77.550 | | |

Example 5. Extraction Efficiency of 3 stacked gels DES-EA-DMSO-1:2:2. Individual Gels were made of same formulation and same technique, as in Example 4, except that three stacked gels were tested with 250 mg/l 2-nitrophenol.

TABLE 4
Extraction efficiency of example embodiment gel (three stacked gels, CIN-DeA (1:1),
DES:EA 1:2, PEGDA 20 wt. % EA, PI 5 wt % EA, 2 ml DMSO)

| | | | | |
|---|---|---|---|---|
| Average | 0.045 | 0.041 | 0.045 | 0.044 |
| Blank | | | | |

Three stacked gels, CIN-DeA (1:1), DES: EA 1:2, PEGDA 20 wt. %
EA, PI 5 wt % EA, 2 ml DMSO. Poured (Hair dryer used to dry)

| | Absorbance | | Final | Extraction | Average | |
|---|---|---|---|---|---|---|
| Initial | From | Corrected | Concentration | Efficiency | Extraction | Standard |
| Concentration | Instrument | Absorbance | mg/L | % | Efficiency % | Deviation |
| 250 | 0.908 | 0.864 | 43.54 | 82.584 | 82.465 | 0.097 |
| 250 | 0.914 | 0.870 | 43.84 | 82.465 | | |
| 250 | 0.92 | 0.876 | 44.14 | 82.346 | | |

Example 6. CIN-DeA (1:1), DES:EA (1:2), PEGDA 20 wt. % EA, PI-5 wt % EA, 2 ml DMSO. Each gel of the same formulation was tested individually with eight different concentrations of 2-nitrophenol, i.e., 50 mg/L, 100 mg/L, 150 mg/L, 200 mg/L, 250 mg/L, 300 mg/L, 400 mg/L, and 500 mg/L. Triplicates of each filtrate were analyzed using=UV-Vis. A calibration curve was used to determine the final concentration after filtration.

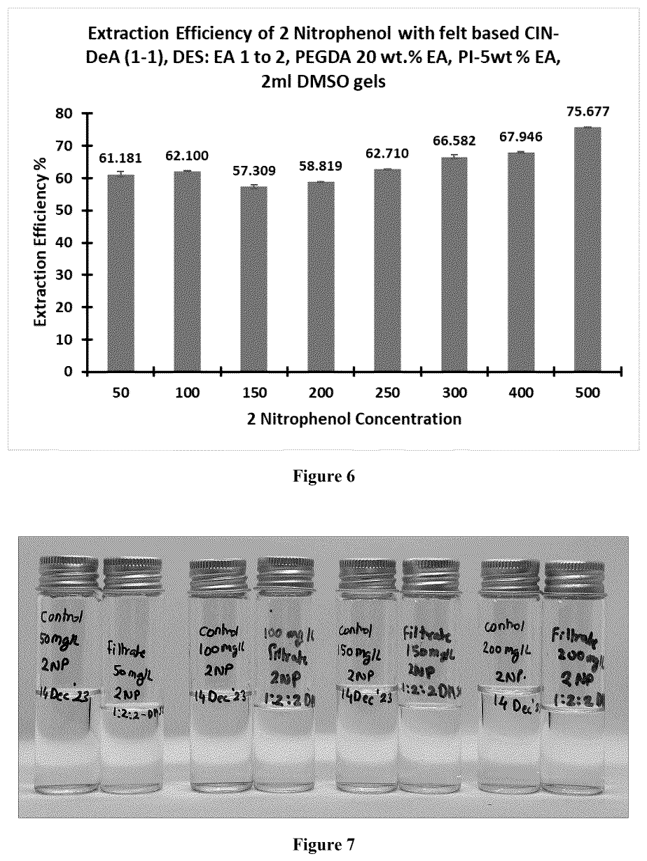

Performance results are given in FIG. 6. Efficiencies of extraction varied between 60 and 75%, with an increase in efficiency at higher concentrations of 2-nitrophenol. The marked change in color between the control solutions (containing 2-nitrophenol at the indicated concentrations) and the filtrate after passing through the gel is shown in FIG. 7.

1. A eutectic gel for filtration of organic contaminants from water, comprising:
a eutectic solvent, wherein the eutectic solvent comprises
a terpenoid or quaternary ammonium salt HBA, and
an organic HBD; and
a gel matrix comprising a polymer capable of forming a gel.

2. The eutectic gel of claim 1, further comprising:
a backer incorporated into or attached to the gel matrix.

3. The eutectic gel of claim 1, wherein
the HBA comprises a terpenoid selected from one or more of thymol, menthol, piperitone, linalyl acetate, eugenol, citronellol, linalool, geraniol, and 1,8-cineole.

4. (canceled)

5. The eutectic gel of claim 1, wherein
the HBA comprises a quaternary ammonium salt selected from one or more of choline chloride; tetraethylammonium bromide; tetramethylammonium chloride; tetrabutylammonium bromide; benzyltrimethylammonium chloride; cetyltrimethylammonium bromide; methyltrioctylammonium chloride; tetrabutylammonium hydrogen sulfate; hexadecyltrimethylammonium bromide; tetrakis(hydroxymethyl)phosphonium chloride; tetraoctylammonium bromide; tri-n-octylmethylammonium chloride; tetrabutylammonium bromide.

6. The eutectic gel of claim 1, wherein the organic HBD comprises a glycol, terpene, sugar, fatty acid, polyol, amino acid, organic acid, glycerol or urea.

7. The eutectic gel of claim 6, wherein the HBD is a medium-chain fatty acid, selected from lauric acid, linoleic acid, decanoic acid, caproic acid, caprylic acid.

8. The eutectic gel of claim 7, wherein the HBD comprises decanoic acid.

9. The eutectic gel of claim 2, wherein the backer incorporated into or attached to the gel matrix comprises paper, nylon, or felt.

10. The eutectic gel of claim 9, wherein backer incorporated into or attached to the gel matrix comprises felt.

11. The eutectic gel of claim 1, wherein the gel matrix comprises a cross-linked polymer.

12. The eutectic gel of claim 11, wherein the cross-linked polymer is derived from ethyl acetate and PEDGA subunits.

13. (canceled)

14. A method of making a eutectic gel, comprising:
combining a terpenoid or quaternary ammonium salt HBA and
an organic HBD to form a eutectic solvent;
combining the eutectic solvent with a gel precursor solution and a porogenic solvent in a gelation chamber;
gelling the combined eutectic solvent and gel precursor solution.

15. The method of claim 14, further comprising
adding a backer to the gelation chamber prior to gelling the combined eutectic solvent and gel precursor solution.

16. (canceled)

17. (canceled)

18. (canceled)

19. (canceled)

20. (canceled)

21. (canceled)

22. (canceled)

23. (canceled)

24. The method of claim 14, wherein gelling the combined eutectic solvent and gel precursor solution further comprises curing the gel via heat treatment, chemical treatment or under UV light.

25. (canceled)

26. The method of claim 24, wherein the gel precursor solution comprises ethyl acetate, PEDGA, DMSO and 1-hydroxycyclohexyl phenyl ketone.

27. A method of filtering organic contaminants from water, comprising
placing at least one eutectic gel, comprising a collection surface and filtration surface in contact with water to be filtered on the filtration surface;
collecting filtered water that has passed through the eutectic gel.

28. The method of claim 27, further comprising increasing flow of water through the eutectic gel via vacuum pressure on the collection surface.

29. The method of claim 27, wherein the eutectic gel comprises:
a eutectic solvent, wherein the eutectic solvent comprises
a terpenoid or quaternary ammonium salt HBA, and
an organic HBD; and
a gel matrix comprising a polymer capable of forming a gel.

30. The method of claim 29 wherein the eutectic gel further comprises:
a backer incorporated into or attached to the gel matrix.

31. (canceled)

32. (canceled)

33. (canceled)

34. (canceled)

35. (canceled)

36. (canceled)

37. (canceled)

38. (canceled)

39. (canceled)

40. (canceled)

41. (canceled)

42. (canceled)

43. The method of claim 27, wherein the eutectic gel may be washed and reused after reaching capacity.
